(19) United States
(12) Patent Application Publication
(10) Pub. No.: US 2025/0341623 A1
(43) Pub. Date: Nov. 6, 2025

(54) A METHOD AND A NODE FOR ESTIMATING TRAVELLING SPEED OF A WIRELESS DEVICE

(71) Applicant: Telefonaktiebolaget LM Ericsson (publ), Stockholm (SE)

(72) Inventors: Niklas JALDÉN, Enköping (SE); Magnus THURFJELL, Luleå (SE)

(21) Appl. No.: 18/855,539

(22) PCT Filed: Jul. 1, 2022
(86) PCT No.: PCT/SE2022/050666

§ 371 Date: Oct. 9, 2024

(51) Int. Cl. G01S 11/10; G01S 5/02; H04W 64/00

(52) U.S. Cl. CPC G01S 11/10; G01S 5/0252; H04W 64/006

(57) ABSTRACT

A computer-implemented method for estimating a travelling speed of a wireless device in a wireless communications network, where the wireless device has transmitted a signal sequence to a network node via two or more signal paths. The method includes obtaining data indicative of a Doppler speed difference between respective multipath components of the signal sequence transmitted via the two or more signal paths; obtaining data indicative of direction of departure, DoD, (n̅_{UE,P1}, n̅_{UE,P2}) of the two or more signal paths at the wireless device; and estimating the travelling speed of the wireless device based on the data indicative of the Doppler speed difference and the data indicative of DoD.

### TECHNICAL FIELD

The present disclosure relates to estimating a travelling speed of a wireless device in a wireless communications network. In particular, the present disclosure relates to a computer-implemented method for estimating travelling speed of a wireless device, a node for estimating travelling speed of a wireless device, a computer program, and a carrier.

### BACKGROUND

A common way of measuring speed of vehicles is to deploy speed cameras using Doppler radars along roads of interest. A Doppler radar transmits a microwave signal which is reflected on a desired target. The Doppler radar receives the reflected signal and analyzes how the motion of the target has shifted the frequency of the received signal. The frequency shift is proportional to a radial component of the speed of the target relative to the Doppler radar. The frequency of the received signal becomes higher if the target travels towards the Doppler radar and the frequency becomes lower of the target moves away from the Doppler radar.

Unfortunately, deployment and maintenance of Doppler radars are costly. In addition, a Doppler radar may measure the speed of vehicles on the specific section on road at which it is deployed.

The speed of a vehicle may also be determined by a vehicle's satellite navigation system such as the global positioning system (GPS) or the global navigation satellite system (GLONASS). However, data from the vehicle's satellite navigation system is typically not readily available by a party that normally would measure the speed of the vehicle using Doppler radars, at least not available at a frequency high enough to provide accurate speed estimation.

In the vehicular industry, there is a rapid increase in the number of connected vehicles. More and more manufacturers offer internet connection in vehicles to supply multimedia experience, navigation, and feature/functionality upgrades to name a few. It is expected that most of the manufactured vehicles will be connected in the future. Each vehicle, as any other connected device like mobile phones, is likely to have a subscriber identity module, which may be a physical device or be software implemented. Thereby, vehicle will be uniquely identifiable. From a network point of view, the type of wireless device, such as vehicle and cellular phone, may for example be distinguishable through the international mobile equipment identity (IMEI) number.

Positioning of wireless devices in wireless communications networks has been used for emergency call positioning since the mid-nineties. With the introduction of fourth generation of broadband cellular network technology (4G), and in particular with the fifth generation of broadband cellular network technology (5G), positioning has seen vast improvements in terms of accuracy, reliability, latency etc. Such positioning techniques may be used to estimate speed of a wireless device by comparing two different positions at two different time instances. However, this only provides an average speed between the two positions, which may not provide sufficient information for a third party if positions are far apart. In other words, the position data may not be available at a frequency high enough to provide accurate speed estimation.

### SUMMARY

It is an object of the present disclosure to mitigate, alleviate or eliminate one or more of the above-identified deficiencies and disadvantages in the prior art and solve at least the above mentioned problem. In particular, an object is to provide improved ways of estimating travelling speed of a wireless device in a wireless communications network. This object is obtained at least in part by a computer-implemented method for estimating a travelling speed of a wireless device in a wireless communications network, where the wireless device has transmitted a signal sequence to a network node via two or more signal paths. The method comprises obtaining data indicative of a Doppler speed difference between respective multipath components of the signal sequence transmitted via the two or more signal paths. The method further comprises obtaining data indicative of direction of departure (DoD) the two or more signal paths at the wireless device. The method also comprises estimating the travelling speed of the wireless device based on the data indicative of the Doppler speed difference and the data indicative of DoD.

The disclosed method for estimating travelling speed of a wireless device, such as a vehicle, may use existing signaling present in wireless communications networks, e.g., 4G, 5G, and beyond. This allows detecting travelling speed of wireless devices in the wireless communications network using existing hardware. This removes the need for deploying a secondary infrastructure, such as speed cameras, which is an advantage. The method also enables speed detection with a ubiquitous coverage area, in contrast to the local spot detection available in todays speed cameras. Hence, estimation of travelling speed of a wireless device in a wireless communications network is improved.

According to some aspects, the signal sequence has been transmitted at two or more time instances. This provides additional data that may be used to improve estimation of the Doppler speed difference.

According to some aspects, the signal sequence comprises a sounding reference signal (SRS) and/or a demodulation reference signal (DMRS). Such signals is commonly used in networks based on 4G, 5G, and beyond for estimating uplink channel quality of the wireless device.

According to some aspects, the data indicative of the Doppler speed difference is obtained based on multipath components of the signal sequence received by the network node. Doppler speed and/or Doppler speed difference of multipath components of the signal sequence received by the network node may already have been estimated for communication in the wireless communications network. In other words, data indicative of the Doppler speed difference may already be present in existing wireless communications networks.

According to some aspects, the data indicative of DoD is obtained based on signal characteristics of multipath components of the signal sequence received by the network node.

These signal characteristics may comprise direction of arrival (DoA) and/or time of arrival (ToA). The signal characteristics of received multipath components at the network node may be transformed to signal characteristics, such as DoD, of transmitted multipath components at the wireless device. Furthermore, signal characteristics of multipath components of the signal sequence received by the network node may already have been estimated for communication in the wireless communications network. Therefore, obtaining data indicative of DoD from received signal characteristics does not require much additional computations in the wireless communications network.

According to some aspects, the data indicative of DoD is obtained based on a relative position between the wireless device and the network node. The relative position may be used for transforming signal characteristics of received multipath components at the network node to signal characteristics of transmitted multipath components at the wireless device.

According to some aspects, the relative position is obtained based on global navigation satellite system (GNSS) data indicative of a position of the wireless device. Alternatively, or in combination of, the relative position is obtained based on fingerprinting-based positioning using multipath components of the signal sequence received by the network node. Positing data from any of these two ways may already be present in the wireless communications network.

According to some aspects, the wireless device has transmitted the signal sequence to the network node via at least three signal paths. Corresponding data indicative of a Doppler speed difference between respective multipath components of the signal sequence transmitted via the three or more signal paths, and corresponding data indicative of direction of departure (DoD) the three or more signal paths at the wireless device may be used for an improved estimation of the travelling speed of the wireless device. More than three multipath components with respective paths may lead to an overdetermined system. In that case, methods like ordinary least squares may be used to calculate an approximate solution to the overdetermined system.

According to some aspects, the method comprises obtaining data indicative of a direction in which the wireless device is travelling, and estimating the travelling speed of the wireless device based on the data indicative of a direction in which the wireless device is travelling. The data indicative of a direction in which the wireless device is travelling may be used for an improved estimation of the travelling speed of the wireless device.

According to some aspects, the data indicative of a direction in which the wireless device is travelling is obtained from map data indicative of an environment around the wireless device. Such data may be readily available in the wireless communications network. Alternatively, or in combination of, the data indicative of a direction in which the wireless device is travelling is obtained from historical position data indicative of one or more previous positions of the wireless device. This provides a computationally efficient way of estimating the direction in which the wireless device is travelling.

According to some aspects, one signal path is line-of-sight (LoS). This normally provides a multipath component with relatively high signal strength. Furthermore, data such as a relative distance between the wireless device and network node may easily be obtained from a LoS multipath component.

According to some aspects, one signal path comprises a predetermined area of reflection. For example, for a given network node, there may be a surface, such as road sign or a building, that provides a reflected path for a multipath component, transmitted from the wireless device to the network node, for a portion of a road in the coverage area of the network node. Since this surface is stationary relative to the network node, a multipath component with a DoA corresponding to the direction to that surface may purposely be selected for the disclosed method. In other words, the reception of the network node may be partially directed towards the surface.

There is also disclosed herein a node for estimating travelling speed of a wireless device in a wireless communications network, where the wireless device has transmitted a signal sequence to a network node via two or more signal paths. The node is associated with the above discussed advantages. The node comprises a processing circuitry and a memory. The processing circuitry is configured to obtain data indicative of a Doppler speed difference between respective multipath components of the signal sequence transmitted via the two or more signal paths, and to obtain data indicative of direction of departure (DoD) of the two or more signal paths at the wireless device. The processing circuitry is further configured to estimate the travelling speed of the wireless device based on the data indicative of the Doppler speed difference and the data indicative of DoD.

There is also disclosed herein a computer program product comprising instructions which, when executed on at least one processing circuitry, cause the at least one processing circuitry to carry out the method according to the discussion above. The computer program is associated with the above discussed advantages.

There is also disclosed herein a computer program carrier carrying a computer program product according to the discussion above, wherein the computer program carrier is one of an electronic signal, optical signal, radio signal, or computer-readable storage medium. The computer program carrier is associated with the above discussed advantages.

### BRIEF DESCRIPTION OF THE DRAWINGS

With reference to the appended drawings, below follows a more detailed description of embodiments of the present disclosure cited as examples. In the drawings:

FIG. 1 is a schematic illustration of a wireless communications network;

FIG. 2 is a schematic illustration of a wireless device communicating with a network node;

FIGS. 3 and 4 show example wireless devices;

FIG. 5 is a flow chart illustrating a method;

FIG. 6 schematically illustrates a network node;

FIG. 7 schematically illustrates a wireless device; and

FIG. 8 schematically illustrates a remote data processing unit.

### DETAILED DESCRIPTION

The present disclosure is described below with reference to the accompanying drawings, in which certain aspects of the present disclosure are shown. The present disclosure may, however, be embodied in many different forms and should not be construed as limited to the embodiments and aspects set forth herein; rather, these embodiments are provided by way of example so that this disclosure will be thorough and complete, and will fully convey the scope of the present disclosure to those skilled in the art. Like numbers refer to like elements throughout the description.

It is to be understood that the present disclosure is not limited to the embodiments described herein and illustrated in the drawings; rather, the skilled person will recognize that many changes and modifications may be made within the scope of the appended claims.

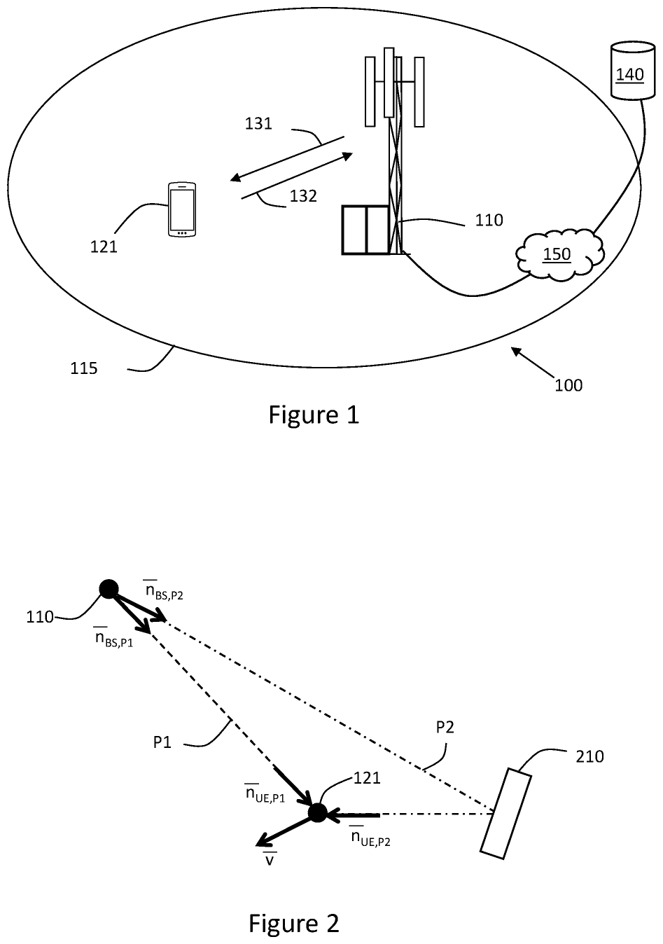

FIG. 1 depicts a wireless communications network 100 in which embodiments herein may operate. In some embodiments, the wireless communications network 100 may be a radio communications network, such as, 6G, NR or NR+ telecommunications network. However, the wireless communications network 100 may also employ technology of any one of 3/4/5G, LTE, LTE-Advanced, WCDMA, GSM/EDGE, WiMax, UMB, GSM, or any other similar network or system. The wireless communications network 100 may also employ technology transmitting on millimeter-waves (mmW), such as, e.g. an Ultra Dense Network, UDN. In some embodiments, the wireless communications network 100 may also employ transmissions supporting WiFi transmissions, e.g. the wireless communications standard IEEE 802.11ad or similar, or other non-cellular wireless transmissions.

The wireless communications network 100 comprises a network node 110. The network node 110 may serve wireless devices in at least one cell 115, or coverage area. The network node 110 may correspond to any type of network node or radio network node capable of communicating with a wireless device and/or with another network node, such as, a base station (BS), a radio base station, gNB, eNB, eNodeB, a Home NodeB, a Home eNodeB, a femto Base Station (BS), or a pico BS in the wireless communications network 100. Further examples of the network node 110 may be a repeater, multi-standard radio (MSR) radio node such as MSR BS, network controller, radio network controller (RNC), base station controller (BSC), relay, donor node controlling relay, base transceiver station (BTS), access point (AP), transmission points, transmission nodes, a Remote Radio Unit (RRU), a Remote Radio Head (RRH), nodes in distributed antenna system (DAS), or core network node. The network node 110 may be arranged to communicate with a remote data processing unit 140 via a core network 150 of the wireless communications network 100. The remote data processing unit 140 may, for example, be a remote standalone server, a cloud-implemented server, a distributed server, dedicated data processing resources in a server farm, or similar.

Furthermore in FIG. 1, a wireless device 121 is located within the cell 115. The wireless device 121 is configured to communicate within the wireless communications network 100 via the network node 110 over a radio link served by the network node 110. The wireless devices 121 may transmit data over an air or radio interface to the radio base station 110 in uplink, UL, transmissions 132 and the radio base station may transmit data over an air or radio interface to the first wireless device 121 in downlink, DL, transmissions 131. The wireless devices 121 may refer to any type of wireless devices or user equipment (UE) communicating with a network node and/or with another wireless device in a cellular, mobile or radio communication network or system. Examples of such wireless devices are mobile phones, cellular phones, Personal Digital Assistants (PDAs), smart phones, tablets, sensors equipped with a UE, Laptop Mounted Equipment (LME) (e.g. USB), Laptop Embedded Equipment (LEE), Machine Type Communication (MTC) devices, or Machine to Machine (M2M) device, Customer Premises Equipment (CPE), target device, device-to-device (D2D) wireless device, wireless device capable of machine to machine (M2M) communication. In particular, the wireless device may be a vehicle or be integrated in a vehicle. A vehicle may, e.g., be a wagon, bicycle, motor vehicle, aircraft, railed vehicle, and watercraft.

As part of the developing of the embodiments described herein, it has been realized that most wireless communications networks are deployed to get ubiquitous area coverage, meaning that using network nodes, such as radio base stations, may enable vehicle speed monitoring for any outdoor location, given there is mobile communication coverage, without additional hardware cost.

As advanced antenna systems (AAS) have shown to give an increased throughput and capacity in wireless communications networks through the use of beamforming and user multiplexing, a large portion of newly deployed sites are being deployed with AAS. An AAS may also be referred to as a massive multiple-input and multiple-output (MIMO) system. An AAS comprises a radio with an antenna array, i.e., a plurality of connected antennas/antenna elements capable of operating together as a single antenna, and signal processing supporting AAS features such as beamforming and MIMO. Is wireless communication networks where a network node, such as a radio base station, comprises an antenna array, it is common to use reciprocity-based channel information acquisition methods. In such methods, the wireless device transmits a training sequence like a sounding reference symbol (SRS) to the network node. The training sequence allows the network node to obtain channel information for its antennas receiving the sequence.

With an antenna array, it is possible to distinguish signal components of the training sequence which has reached the antenna array by different paths, i.e., multipath propagation. By combining received multipath components of separate receive antennas in the antenna array, it is possible to estimate the direction of arrival (DoA) of the multipath components at the network node. Furthermore, by linear transformations of multipath components over frequency domain, e.g., it is possible to estimate time of arrival (ToA) and/or propagation distance of other multipath components. There are several multipath component estimation methods in the literature, from pure DoA estimation methods like multiple signal classifier and estimation of signal parameters via rotational invariance technique (MUSIC & ESPRIT) to more elaborate estimation methods like space alternating generalized expectation maximization (SAGE). In other words, it is well-known how to obtain various signal characteristics (such as DoA, ToA, and propagation distance) of multipath components received by the network node.

The present disclosure presents a method for estimating travelling speed (measured in, e.g., m/s) of a wireless device, such as a vehicle, which may use existing signaling present in wireless communications networks, e.g., 4G, 5G, and beyond. The method is based on the realization that channel information of multipath components of a signal transmitted by the wireless device, such as direction of departure, may be used together with Doppler speed data for the multipath components to estimate the travelling speed of the device. This enables estimation of traveling speeds of wireless devices in the wireless communications network using existing hardware. This removes the need for deploying a secondary infrastructure, such as speed cameras, which is an advantage. The method furthermore enables speed detection with a ubiquitous coverage area, which is in contrast to the local spot detection available in todays speed cameras.

FIG. 2 shows a schematic illustration of a wireless device 121 communicating with a network node 110. The wireless device has a transmitted a signal sequence, such as a reference signal training sequence like SRS. The network node has received a first and a second multipath component of the signal sequence via a first path P1 and via a second path P2, respectively. In this example, the first path P1 is line of sight (LoS). The multipath component has been reflected on an object 210, such as a road sign or a building. The wireless device has a velocity vector v̅, which may be expressed in terms of a travelling speed v and a unit vector n̅ᵥ (referred to herein as travel direction vector) according to v̅=vn̅ᵥ. Note that the travel direction vector may be related to an intended direction. For example, the travel direction vector may point in the intended driving direction along a lane of a road. In that case, the travelling speed v may be negative, e.g., if the wireless device is travelling in the wrong direction along a lane.

As is also shown in in FIG. 2, the direction of departure (DoD) of the first and the second multipath components at the wireless device, i.e., the directions of the respective paths at the wireless device, may be expressed as unit vectors n̅_{UE,P1} and n̅_{UE,P2}, respectively. The direction of arrival (DoA) of the first and the second multipath components at the network node, i.e., the directions of the respective paths at the network node, may be expressed as unit vectors n̅_{BS,P1} and n̅_{BS,P2}, respectively. In the example of FIG. 2, n̅_{UE,P1} and n̅_{UE,P2} are directed towards the wireless device and n̅_{BS,P1} and n̅_{BS,P2} are directed away from the network node. However, any of these four vectors could alternatively be defined in respective opposite directions. A unit vector is a spatial vector of length 1. The unit vectors may be coordinateness in a reference system relating to, e.g., a main lobe of an antenna system of the network node or of the wireless device. The reference system may alternatively, or in combination of, be based on a standard like the world geodetic system (WGS).

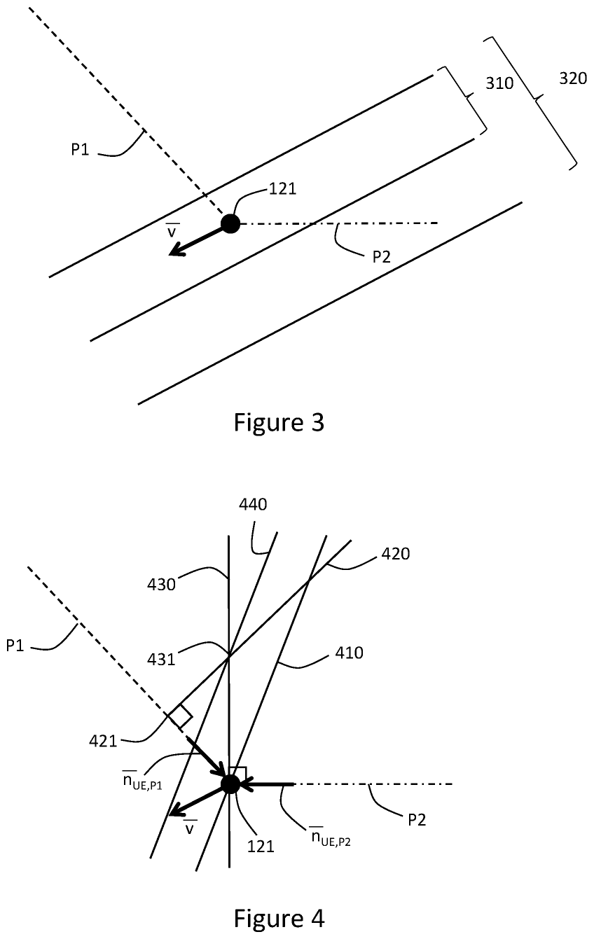

FIG. 3 shows a schematic illustration of an example scenario for the wireless device 121 from FIG. 2. Here, the wireless device is travelling along a lane 310 on a road 320 with a velocity vector v in a direction along the lane. The travel direction vector n̅ᵥ is preferably expressed in the same reference system as n̅_{UE,P1}, n̅_{UE,P2}, n̅_{BS,P1}, and n̅_{BS,P2}.

The travelling speed of the wireless device 121 results frequency shifts of the multipath components due to the Doppler Effect. The Doppler Effect impacts each multipath component individually depending on their individual direction in relation to the movement of the wireless device. It is possible to obtain a Doppler speed information for each multipath component based on their respective frequency shifts. Therefore, it is possible to estimate the travelling speed of a wireless device based on the Doppler speed information and DoD of the paths of the multipath components at the wireless device. The DoD may, e.g., be calculated from DoA of the paths of the multipath components at the network node.

For example, for two multipath components at the wireless device, the Doppler speed at the respective directions of the two multipath components may be expressed as a scalar projection of the velocity onto the unit vectors n̅_{UE,P1} and n̅_{UE,P2}, respectively, i.e.,

$$\{ \begin{matrix}v {\overline{n}}_{v} \cdot {\overline{n}}_{UE , P 1} = {D}_{P 1} \\ v {\overline{n}}_{v} \cdot {\overline{n}}_{UE , P 2} = {D}_{P 2}\end{matrix}$$

Here, the sign “·” denotes scalar product. D_{P1} and D_{P2} are speeds in the directions of n̅_{UE,P1} and n̅_{UE,P2}, respectively, measured in, e.g., m/s. D_{P1} and D_{P2} are referred to as Doppler speeds herein.

According to the Doppler Effect, the frequency shift of a multipath component transmitted by the wireless device is proportional to a speed component obtained from a scalar projection of a velocity vector of the wireless device onto the transmitted direction (i.e., the DoD) of that multipath component. This speed component is called a Doppler speed of that multipath component herein.

Sometimes it is more convenient to obtain a Doppler speed difference between multipath components than obtaining absolute values of the Doppler speeds. In the example above, the Doppler speed difference may be express as D_{diff}=D_{P2}−D_{P1}. In that case, the equation system above may be written as

$$v {\overline{n}}_{v} \cdot ( {\overline{n}}_{UE , P 2} - {\overline{n}}_{U E , P 1} ) = {D}_{d i f f}$$

The value D_{diff} may be obtained directly or be calculated from D_{P1}, and D_{P2}, i.e., obtaining D_{P1}, and D_{P2} and then calculating D_{diff}. This equation shows that the travelling speed of the wireless device 121 may be estimated based on data indicative of DoD of the two or more signal paths at the wireless device and on data indicative of a Doppler speed difference between respective multipath components of the signal sequence transmitted from the wireless device to a network node via the two or more signal paths.

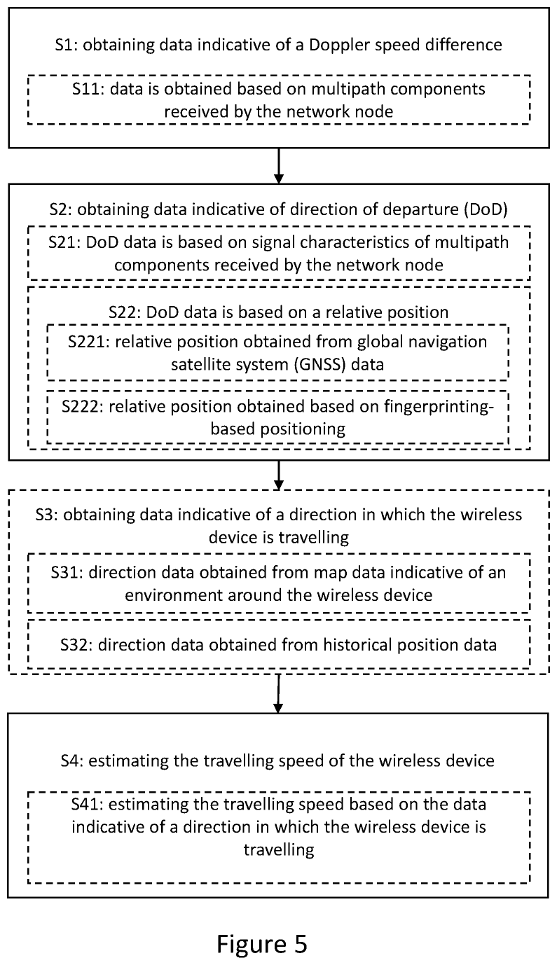

Therefore, with reference to the flowchart depicted in FIG. 5, there is disclosed herein a computer-implemented method for estimating a travelling speed of a wireless device 121, where the wireless device has transmitted a signal sequence to a network node 110 via two or more signal paths P1, P2. In particular, FIG. 5 illustrates examples of actions or operations which may be taken by, e.g., a computer, a node such as a network node 110 or wireless device 121, processing circuitry, and/or a remote data processing unit 140.

The method comprises obtaining S1 data indicative of a Doppler speed difference between respective multipath components of the signal sequence transmitted via the two or more signal paths P1, P2. The method further comprises obtaining S2 data indicative of direction of departure (DoD) n̅_{UE,P1}, n̅_{UE,P2} of the two or more signal paths P1, P2 at the wireless device 121. The method also comprises estimating S4 the travelling speed of the wireless device 121 based on the data indicative of the Doppler speed difference and the data indicative of DoD.

The signal sequence preferably is a training sequence known by the network node, such as sounding reference signal (SRS), a demodulation reference signal (DMRS), a phase tracking reference signal (PTRS), and/or a channel state information reference signal (CSI-RS). In general, however, the signal sequence is sequence that makes it possible to obtain channel information/signal characteristics, such as DoA and ToA, of two or more multipath components.

The SRS is an orthogonal frequency division multiplexing (OFDM) signal comprising a Zadoff-Chu sequence on different subcarriers. An SRS may advantageously be used to estimate the channel for large bandwidths outside a span assigned to the wireless device. The SRS typically comprises a plurality of SRS symbols with respective subcarriers which may, e.g., be transmitted every frame or even at every second subframe. To obtain Doppler speed from a multipath component, two or more SRS symbols for a subcarrier may be required. However, if the SRS symbols are transmitted at different frames, the two or more SRS symbols are likely not time coherent. In that case, it may only be possible to calculate the Doppler speed difference for two received multipath components. Therefore, the signal sequence of the disclosed method may have been transmitted at two or more time instances. Although the wireless device has moved between the different time instances, the paths of the multipath components remain approximately the same. For example, if the travelling speed is 100 km/h, the vehicle moves about 3 cm between subframes of 1 ms each, which is negligible if the distance between the wireless devise and the network node is, e.g., a 1000 times larger. Thus, multipath components transmitted at two or more time instances are approximated to travel along the same respective paths at the two or more time instances. In other words, the different paths are approximated to remain the same for the two or more time instances. Furthermore, if two or more SRS symbols for a subcarrier are time coherent, the respective Doppler speeds for different multipath components may be obtained.

The data indicative of a Doppler speed difference between respective multipath components of the signal sequence transmitted via the two or more signal paths P1, P2 may comprise respective Doppler speeds for one or more multipath components and/or a Doppler speed difference between one or more multipath components. For example, for three multipath components, the data may comprise two values of the Doppler speed difference, i.e., between a first component and a second component and between the first component and a third component.

The data indicative of DOD n̅_{UE,P1}, n̅_{UE,P2} of the two or more signal paths P1, P2 at the wireless device 121 may comprise respective vectors for each signal path. Alternatively, or in combination of, the data may comprise a difference in DoD between different signal paths, such as one unit vector minus another or an angle between two vectors. Similar to the discussion above, the data indicative of DoD may be expressed in various coordinate systems and in various reference systems.

The network node preferably comprises an AAS according to the discussions above. Thus, the data indicative of the Doppler speed difference may be obtained S11 based on multipath components of the signal sequence received by the network node 110. Doppler speed and/or Doppler speed difference of multipath components of the signal sequence received by the network node may already have been estimated for communication in the wireless communications network. In other words, data indicative of the Doppler speed difference may already be present in existing wireless communications networks.

Similarly, the data indicative of DoD may be obtained S21 based on signal characteristics of multipath components of the signal sequence received by the network node 110. Such signal characteristics may, e.g., comprise direction of arrival (DoA) and/or time of arrival (ToA). The signal characteristics of received multipath components at the network node may be transformed to signal characteristics of transmitted multipath components at the wireless device. For example, DoD may be calculated using DoA and ToA.

The data indicative of DoD may be obtained S22 based on a relative position between the wireless device 121 and the network node 110. The relative position may be used for transforming signal characteristics of received multipath components at the network node to signal characteristics of transmitted multipath components at the wireless device. For example, DoD may be calculated using DoA, ToA, and the relative position. The relative position may be obtained from relating coordinates of the wireless device in a reference system to coordinates of the network node in the same reference system. Alternatively, or in combination, the relative position may be a distance between the wireless device and the network node.

The relative position may be obtained S221 based on global navigation satellite system (GNSS) data indicative of a position of the wireless device 121. Such data may be available since the wireless device may regularly report is position obtained from GNSS data to various layers in the wireless communications network. The various layers may be layers of the communication control stack and/or of the application stack. The position of the network node in a corresponding reference system is assumed to be known.

Alternatively, or in combination of, the relative position may be obtained S222 based on fingerprinting-based positioning using multipath components of the signal sequence received by the network node 110. Fingerprinting means to map current signal characteristics, i.e., a fingerprint, to a set of previously obtained fingerprints, where the previously obtained fingerprints have been obtained for different positions of the wireless device. Thus, if a current fingerprint corresponds to a previously stored fingerprint, it may be assumed that the current position of the wireless device corresponds to the position for the previously obtained fingerprint. Fingerprinting-based positioning may be combined with machine-learning methods for improved accuracy. Fingerprinting-based positioning in wireless communications networks is known in general and will there not be discussed further herein.

With an obtained DoD of two multipath components and a Doppler speed difference between those two components. It is possible to obtain a set of possible velocity vectors for the wireless device. As is mentioned above, the Doppler speed difference may be express as the scalar product of the velocity of the wireless device and the difference in unit direction vectors of the DoD, i.e., vn̅ᵥ·(n̅_{UE,P2}−n̅_{UE,P1})=D_{diff}. With this information, it is possible to calculate the travelling speed v using, e.g., a known travel direction vector n̅ᵥ and/or DoD and Doppler speed of a third multipath component. Therefore, the wireless device 121 has, according to some aspects, transmitted the signal sequence to the network node 110 via at least three signal paths P1, P2. More than three multipath components with respective paths may lead to an overdetermined system. In that case, methods like ordinary least squares may be used to calculate an approximate solution to the overdetermined system.

As mentioned above, it is possible to calculate the travelling speed v using, e.g., a known travel direction vector n̅ᵥ. Therefore, the method may comprise obtaining S3 data indicative of a direction in which the wireless device 121 is travelling. The data indicative of a direction in which the wireless device 121 is travelling may comprise the travel direction vector n̅ᵥ, which may be obtained in different ways.

For example, the data indicative of a direction in which the wireless device 121 is travelling may be obtained S31 from map data indicative of an environment around the wireless device 121. Referring back to FIG. 3, such map data may comprise information of road 320 or lane 310 directions for different positions on a map. Such data may be in the form of a vector field. In that case, a plurality of positions on the road may comprise respective unity vector indicating an intended driving direction. An intended driving direction may be along the lane in a right-hand-traffic road system. Such set of unity vectors may be calculated beforehand. A current position of the wireless device may be mapped to the closest position with a vector indicating the intended driving direction. Alternatively, the vector indicating the intended driving direction may be calculated directly from the current position of the wireless device and map data.

Alternatively, or in combination of, the data indicative of a direction in which the wireless device 121 is travelling may be obtained S32 from historical position data indicative of one or more previous positions of the wireless device 121. For example, the travel direction vector n̅ᵥ may be obtained from a vector representing the difference between a current position and a previous position. A plurality of positions may be used to estimate the travel direction vector. For example, an expected path the wireless device is about to traverse may be approximated from a curve fit of the current and previous positions, such as polynomial fit. In that case, the travel direction vector may be the tangent of the estimated curve at the current position.

After obtaining data indicative of a direction in which the wireless device is travelling, the method further comprises estimating S41 the travelling speed of the wireless device 121 based on the data indicative of a direction in which the wireless device 121 is travelling.

One signal path P1, P2 may be line-of-sight (LoS). This normally provides a multipath component with relatively high signal strength, i.e., power. Furthermore, data such as a relative distance between the wireless device and network node may easily be obtained from a LoS multipath component.

One signal path P1, P2 may comprise a predetermined area of reflection. For example, for a given network node, there may be a surface, such as road sign or a building, that provides a reflected path for a multipath component, transmitted from the wireless device to the network node, for a portion of a road in the coverage area of the network node. Since this surface is stationary relative to the network node, a multipath component with a DoA corresponding to the direction to that surface may be purposely selected for the disclosed method. In other words, the reception of the network node may be partially directed towards the surface.

There may be scenarios where multipath propagation is non-existing or where the signal strengths of reflected multipath components is too low to enable accurate speed estimation. In other words, there may be scenarios where there are no good reflection surfaces or similar. Instead of deploying speed cameras on several locations to determine the speed of vehicles, it may be sufficient that a reflective surface like a mirror/billboard or similar is deployed. The location of such reflective surface could be used as input in the disclosed method as discussed above.

The method may also comprise determining a type of the wireless device from a predetermined set of types. The set of types may, e.g., comprise vehicles and non-vehicles. This distinction may, e.g., be used when obtaining the data indicative of a direction in which the wireless device 121 is travelling from map data. For example, an expected direction may be different for a pedestrian and a vehicle. The set of types may further comprise different vehicle types, such as car, truck, bicycle etc. The type of device may for example be distinguishable through an obtained international mobile equipment identity (IMEI) number.

FIG. 4 shows a schematic illustration of an example scenario for the wireless device 121 from FIG. 2. In particular, FIG. 4 shows a geometrical explanation of an example embodiment of the disclosed method. Here, the DoA of two multipath components have been obtained, as well as a Doppler speed difference of x m/s. Line 430 is a line perpendicular to one of the paths of the multipath components at the wireless device, which in this case is P2. Line 420 extends from a point 421 on the other path at the wireless device, i.e., P1, where the point represents the scalar value of x m/s, and is arranged along the path P1 and originates from the wireless device. The line 420 is perpendicular to the path P1 at the wireless device. Line 420 intersects with line 430 at a point 431. Line 440 is drawn through point 431. Line 440 is parallel to a line 410 bisecting the paths P1 and P2 at the wireless device.

Line 440 represents end points of a set of possible velocity vectors of the wireless device, i.e., vectors which start at the wireless device and end at the line 440, when only two multipath components are available. In other words, the line 440 represent velocity vectors that may result in the obtained Doppler speed when analyzing two multipath components. As mentioned, the travelling speed of the wireless device 121 may be determined based on, e.g., the direction in which the wireless device is travelling, i.e., n̅ᵥ. As also mentioned, the data from three or more multipath components may also be used to determine the travelling speed of the wireless device 121 without information of the direction in which the wireless device is travelling. The travelling speed may also be estimated using a combination of both ways.

In another example embodiment, the wireless device is traveling along a road with known direction. The wireless device 121 transmits an SRS symbol incoherently at two different time instances. For the respective time instances, two multipath components are transmitted along a first path P1 and a second path P2, respectively. The multipath components at the two time instances are detected at the network node. One path P1 is LOS and another path P2 is a reflected path. The position of the network node is known. The position of the wireless device is obtained from position data of from some positioning technique. From these two positions, the length lₚ_{₁} of the LoS path P1 is obtained. Length lₚ_{₂} of path P2 is calculated from the ToA of the received multipath components.

Furthermore in the example, the spatial directions of the multipath components at the wireless device, relative to the network node, are obtained from analyzing DoA of the received multipath components at the network node. Using the nomenclature of FIG. 2, the direction vector n̅_{UE,P1} of path P1 at the wireless device is the same as the direction vector n̅_{BS,P1} since the path P1 is LoS. The direction vector n̅_{UE,P2} of path P2 at the wireless device is obtained from the n̅_{BS,P1} and lₚ_{₂}. As mentioned, the travel direction vector n̅ᵥ is known. Furthermore, the Doppler speed difference D_{diff}=D_{P2}−D_{P1} has been extracted from the SRS. This information is sufficient to solve for v using the equations:

$$\{ \begin{matrix}v {\overline{n}}_{v} \cdot {\overline{n}}_{UE , P 1} = {D}_{P 1} \\ v {\overline{n}}_{v} \cdot {\overline{n}}_{UE , P 2} = {D}_{P 2}\end{matrix}$$

There is also disclosed herein a node 110, 121, 140 for estimating travelling speed of a wireless device 121, where the wireless device has transmitted a signal sequence to a network node 110 via two or more signal paths P1, P2. The node may be the network node 110 receiving the signal sequence. However, it may also be a different network node. In that case, the network node receiving the transmitted signal sequence may be referred to as the reception node and the node for estimating travelling speed may be referred to as a processing node. Alternatively, or in combination of, the node for estimating travelling speed may be a wireless device 121 and/or a remote data processing unit 140. The wireless device constituting the node may be the wireless device that has transmitted the signal sequence or another wireless device.

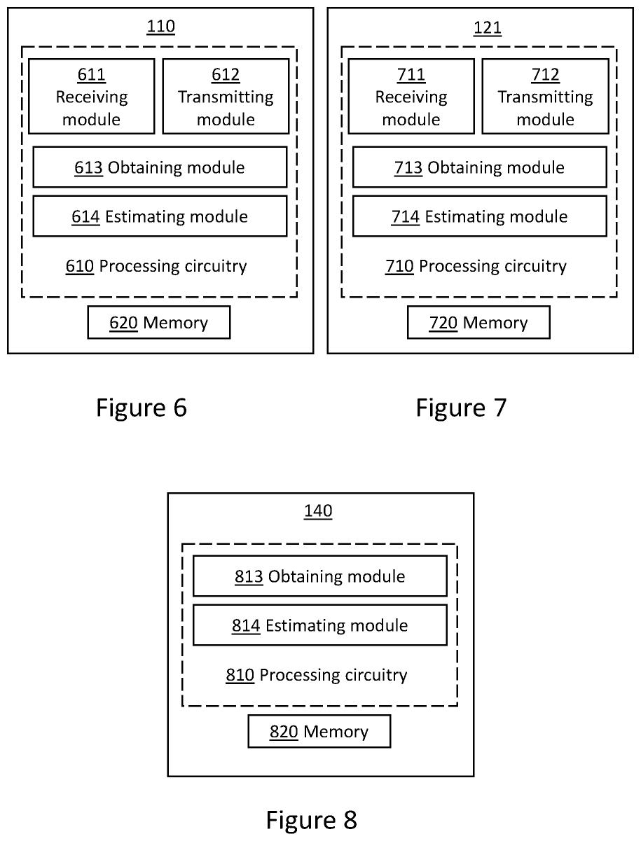

FIG. 6 shows a schematic block diagram of embodiments of a network node 110. FIG. 7 shows a schematic block diagram of embodiments of a wireless device 110. FIG. 8 shows a schematic block diagram of embodiments of a remote data processing unit 140. The embodiments of the node 110, 121, 140 may be considered as independent embodiments or may be considered in any combination with each other. It should also be noted that, although not shown in FIGS. 6-8, the node may comprise known conventional features for such devices, such as a power source like a battery or main connection. If the node is a network node or a wireless device, the conventional features may also be, e.g., an antenna arrangement.

The node 110, 121, 140 may comprise processing circuitry 610, 710, 810 and a memory 620, 720, 820. The processing circuitry 610, 710 of the network node and the wireless device may, in turn, comprise a receiving module 611, 711 and a transmitting module 612, 812, respectively. The receiving module 611, 711 and the transmitting module 612, 712 may comprise radio frequency circuitry and baseband processing circuitry capable of transmitting and receiving a radio signal in the wireless communications network 100. The receiving module 611, 711 and the transmitting module 612, 712 may also form part of a single transceiver. It should also be noted that some or all of the functionality described in the embodiments above as being performed by the node 110, 121, 140 may be provided by the processing circuitry 610, 710, 810 executing instructions stored on a computer-readable medium, such as, e.g. the memory 620, 720, 820 shown in FIGS. 6-8. Alternative embodiments of the node 110, 121, 140 may comprise additional components, such as, an obtaining module 613, 713, 813 and/or an estimating module 614, 714, 814, responsible for providing functionality to support the embodiments of the network node described herein.

The node 110, 121, 140, processing circuitry 610, 710, 810, or obtaining module 613, 713, 813 is configured to obtain data indicative of a Doppler speed difference between respective multipath components of the signal sequence transmitted via the two or more signal paths P1, P2. The node 110, 121, 140, processing circuitry 610, 710, 810, or obtaining module 613, 713, 813 is further configured to obtain data indicative of direction of departure (DoD) n̅_{UE,P1}, n̅_{UE,P2} of the two or more signal paths P1, P2 at the wireless device 121. Furthermore, the node 110, 121, 140, processing circuitry 610, 710, 810, or estimating module 614, 714, 814 is configured to estimate the travelling speed of the wireless device 121 based on the data indicative of the Doppler speed difference and the data indicative of DoD.

In disclosed node 110, 121, 140, the signal sequence has, according to some aspects, been transmitted at two or more time instances. The signal sequence may comprise a sounding reference signal (SRS) and/or a demodulation reference signal (DMRS). Furthermore, the data indicative of the Doppler speed difference may be obtained based on multipath components of the signal sequence received by the network node 110. In addition, the data indicative of DoD may be obtained based on signal characteristics of multipath components of the signal sequence received by the network node 110. Here, the signal characteristics may comprise direction of arrival (DoA) and/or time of arrival (ToA).

Furthermore, in disclosed node 110, 121, 140, the data indicative of DoD may be obtained based on a relative position between the wireless device 121 and the network node 110. The relative position may be obtained from global navigation satellite system (GNSS) data indicative of a position of the wireless device 121. Alternatively, or in combination of, the relative position may be obtained based on fingerprinting-based positioning using multipath components of the signal sequence received by the network node 110. According to some aspects, the wireless device 121 has transmitted the signal sequence to the network node 110 via at least three different signal paths P1, P2.

The node 110, 121, 140, processing circuitry 610, 710, 810, or obtaining module 613, 713, 813 may be configured to obtain data indicative of a direction in which the wireless device 121 is travelling. In that case, the node 110, 121, 140, processing circuitry 610, 710, 810, or estimating module 614, 714, 814 is configured to estimate the travelling speed of the wireless device 121 based on the data indicative of a direction in which the wireless device 121 is travelling. The data indicative of a direction in which the wireless device 121 is travelling may be obtained from map data indicative of an environment around the wireless device 121. Alternatively, or in combination of, the data indicative of a direction in which the wireless device 121 is travelling may be obtained from historical position data indicative of one or more previous positions of the wireless device 121.

In addition, in disclosed node 110, 121, 140, one signal path P1, P2 may be line-of-sight (LoS). Furthermore, one signal path P1, P2 may comprise a predetermined area of reflection. According to some aspects, the node 110, 121, 140, processing circuitry 610, 710, 810, or obtaining module 613, 713, 813 is also configured to determining a type of the wireless device from a predetermined set of types.

The methods disclosed herein may be implemented through one or more processors, such as the processing circuitry 610, 710, 810 in the node 110, 121, 140 depicted in FIGS. 6-8, together with computer program code for performing the functions and actions of the embodiments herein. The program code may also be provided as a computer program product, for instance in the form of a data carrier carrying computer program code or code means for performing the embodiments herein when being loaded into the processing circuitry 610, 710, 810 in the node 110, 121, 140. The computer program code may e.g. be provided as pure program code in the node 110, 121, 140 or on a server and downloaded to the node. Thus, it should be noted that the modules of the node 110, 121, 140 may in some embodiments be implemented as computer programs stored in memory, e.g. in the memory modules 620, 720, 820 in FIGS. 6-8, for execution by processors or processing modules, e.g. the processing circuitry 610, 710, 810 of FIGS. 6-8. Those skilled in the art will also appreciate that the processing circuitry 610, 710, 810 and the memory 620, 720, 820 described above may refer to a combination of analog and digital circuits, and/or one or more processors configured with software and/or firmware, e.g. stored in a memory, that when executed by the one or more processors such as the processing circuitry 610, 710, 810 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above described preferred embodiments. Various alternatives, modifications and equivalents may be used. Therefore, the above embodiments should not be construed as limiting.

1. A computer-implemented method for estimating a travelling speed of a wireless device in a wireless communications network, where the wireless device has transmitted a signal sequence to a network node via two or more signal paths, the method comprising:
obtaining data indicative of a Doppler speed difference between respective multipath components of the signal sequence transmitted via the two or more signal paths;
obtaining data indicative of direction of departure, DoD, (n̅_{UE,P1}, n̅_{UE,P2}) of the two or more signal paths at the wireless device; and
estimating the travelling speed of the wireless device based on the data indicative of the Doppler speed difference and the data indicative of DoD.

2. The method according to claim 1, wherein the signal sequence has been transmitted at two or more time instances.

3. The method according to claim 1, wherein the signal sequence comprises a sounding reference signal, SRS and/or a demodulation reference signal, DMRS.

4. The method according to claim 1, wherein the data indicative of the Doppler speed difference is obtained based on multipath components of the signal sequence received by the network node.

5. The method according to claim 1, wherein the data indicative of DoD is obtained based on signal characteristics of multipath components of the signal sequence received by the network node.

6. The method according claim 5, wherein the signal characteristics comprise direction of arrival, DoA, and/or time of arrival, ToA.

7. The method according to claim 1, wherein the data indicative of DoD is obtained based on a relative position between the wireless device and the network node.

8. The method according to claim 7, wherein the relative position is obtained based on global navigation satellite system, GNSS, data indicative of a position of the wireless device.

9. The method according to claim 7, wherein the relative position is obtained based on fingerprinting-based positioning using multipath components of the signal sequence received by the network node.

10. The method according to claim 1, wherein the wireless device has transmitted the signal sequence to the network node via at least three signal paths.

11. The method according to claim 1, wherein the method comprises obtaining data indicative of a direction in which the wireless device is travelling, and estimating the travelling speed of the wireless device based on the data indicative of a direction in which the wireless device is travelling.

12. The method according to claim 11, wherein the data indicative of a direction in which the wireless device is travelling is obtained from map data indicative of an environment around the wireless device.

13. The method according to claim 11, wherein the data indicative of a direction in which the wireless device is travelling is obtained from historical position data indicative of one or more previous positions of the wireless device.

14. The method according to claim 1, wherein one signal path is line-of-sight, LoS.

15. The method according to claim 1, wherein one signal path comprises a predetermined area of reflection.

16. A node for estimating travelling speed of a wireless device in a wireless communications network, where the wireless device has transmitted a signal sequence to a network node via two or more signal paths, wherein the node comprises a processing circuitry and a memory, the processing circuitry being configured to: obtain data indicative of a Doppler speed difference between respective multipath components of the signal sequence transmitted via the two or more signal paths; obtain data indicative of direction of departure, DoD, (n̅_{UE,P1}, n̅_{UE,P2}) of the two or more signal paths at the wireless device; and estimate the travelling speed of the wireless device based on the data indicative of the Doppler speed difference and the data indicative of DoD.

17. The node according to claim 16, wherein the signal sequence has been transmitted at two or more time instances.

18. The node according to claim 16, wherein the signal sequence comprises a sounding reference signal, SRS and/or a demodulation reference signal, DMRS.

19. The node according to claim 16, wherein the data indicative of the Doppler speed difference is obtained based on multipath components of the signal sequence received by the network node.

20. The node according to claim 16, wherein the data indicative of DoD is obtained based on signal characteristics of multipath components of the signal sequence received by the network node.

21-33. (canceled)
